(19) United States
(12) Patent Application Publication
(10) Pub. No.: US 2026/0127289 A1
(43) Pub. Date: May 7, 2026

(54) INFORMATION PROCESSING SYSTEM, NON-TRANSITORY COMPUTER READABLE MEDIUM, AND NORMALITY GUARANTEE SYSTEM

(71) Applicant: FUJIFILM BUSINESS INNOVATION CORP., Tokyo (JP)

(72) Inventor: Hiroyuki TOJO, Kanagawa (JP)

(73) Assignee: FUJIFILM BUSINESS INNOVATION CORP., Tokyo (JP)

(21) Appl. No.: 19/206,383

(22) Filed: May 13, 2025

(30) Foreign Application Priority Data
Nov. 1, 2024 (JP) 2024-192949

(51) Int. Cl. G06F 21/57

(52) U.S. Cl. CPC G06F 21/575; G06F 21/577; G06F 2221/033

(57) ABSTRACT

An information processing system includes a processor configured to: in response to boot program normality of a boot program of the information processing system being validated after referring to first validation information for validating the boot program normality, boot up the information processing system with the boot program; communicate with one or more different systems registered in advance and mutually validate boot program normality of one or more boot programs of the respective one or more different systems after referring to second validation information for validating the boot program normality of each of the one or more boot programs of a corresponding one of the different systems; and in response to the boot program normality of the boot program of the different system a count of which is greater than or equal to a set count being mutually validated, permit communication with an external apparatus.

### CROSS-REFERENCE TO RELATED APPLICATIONS

This application is based on and claims priority under 35 USC 119 from Japanese Patent Application No. 2024-192949 filed Nov. 1, 2024.

### BACKGROUND

### (i) Technical Field

The present disclosure relates to an information processing system, a non-transitory computer readable medium, and a normality guarantee system.

### (ii) Related Art

Japanese Unexamined Patent Application Publication No. 2009-259160 describes an unauthorized-boot prevention system for a program for performing control to run only authorized programs. The control is performed by using a program designed to run in cooperation with a trusted platform module (TPM) mounted on the mother board of a personal computer (PC).

Japanese Unexamined Patent Application Publication No. 2020-140665 describes a program intended to appropriately ensure the safety in booting up a device.

Japanese Unexamined Patent Application Publication No. 2021-190808 describes an information processing system in which secure management of the Internet of Things (IoT) is combined with secure management of stored data thereof.

### SUMMARY

Unauthorized rewriting of a boot program of an information processing system connectable to the Internet (also called an IoT device) possibly causes a security hole in a network. Accordingly, the normality of a boot program of the information processing system connected to the network is desirably guaranteed.

Aspects of non-limiting embodiments of the present disclosure relate to providing an information processing system, a non-transitory computer readable medium, and a normality guarantee system that are enabled to guarantee boot program normality.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: in response to boot program normality of a boot program of the information processing system being validated after referring to first validation information for validating the boot program normality, boot up the information processing system with the boot program; communicate with one or more different systems registered in advance and mutually validate boot program normality of one or more boot programs of the respective one or more different systems after referring to second validation information for validating the boot program normality of each of the one or more boot programs of a corresponding one of the different systems; and in response to the boot program normality of the boot program of the different system a count of which is greater than or equal to a set count being mutually validated, permit communication with an external apparatus.

### BRIEF DESCRIPTION OF THE DRAWINGS

An exemplary embodiment of the present disclosure will be described in detail based on the following figures, wherein:

FIG. 1 is a view illustrating the system configuration of a normality guarantee system of an exemplary embodiment of the present disclosure;

FIG. 2 is a block diagram illustrating the hardware configuration of a monitoring camera of the exemplary embodiment of the present disclosure;

FIG. 3 is a block diagram illustrating the hardware configuration of an edge server and a cloud server of the exemplary embodiment of the present disclosure;

FIG. 4 is a view for explaining the structure of data of the monitoring camera of the exemplary embodiment of the present disclosure;

FIG. 5 is a flowchart of validation-result verification;

FIG. 6 is a flowchart of program termination;

FIG. 7 is a flowchart of connection validation;

FIG. 8 is a flowchart of the validation-result verification;

FIG. 9 is a chart for explaining mutual-validation result information aggregated in the edge server of the exemplary embodiment of the present disclosure; and

FIG. 10 is a flowchart of system continuation termination.

### DETAILED DESCRIPTION

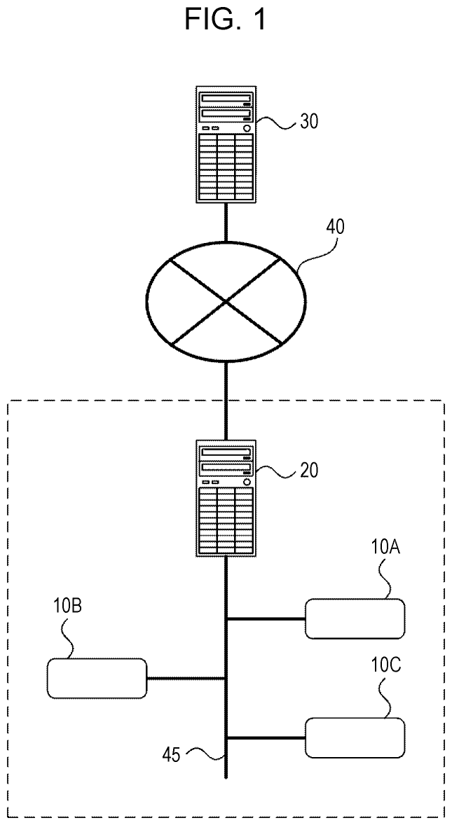

Hereinafter, an exemplary embodiment for implementing technology of the present disclosure will be described in detail with reference to the drawings. FIG. 1 is a view illustrating the system configuration of a normality guarantee system of the exemplary embodiment.

As illustrated in FIG. 1, the normality guarantee system of this exemplary embodiment includes a monitoring camera 10A, a monitoring camera 10B, and a monitoring camera 10C that are connectable to the Internet 40, an edge server 20, and a cloud server 30.

The normality guarantee system is a system enabled to guarantee the normality of respective boot programs of the monitoring camera 10A, the monitoring camera 10B, and the monitoring camera 10C that are connectable to the Internet 40.

The three monitoring cameras that are the monitoring camera 10A, the monitoring camera 10B, and the monitoring camera 10C are illustrated in FIG. 1 but are each referred to as a monitoring camera 10 if discrimination thereamong is not required in the description.

The monitoring camera 10 is an IoT device connectable to the Internet 40. The monitoring camera 10 is connected to the Internet 40 via the edge server 20 (described later). The monitoring camera 10 has an image capturing function and transmits video data acquired by image capturing to the cloud server 30 (described later). The monitoring camera 10 is an example of an information processing system in the technology of the present disclosure.

The edge server 20 is connected to the Internet 40 and a local area network 45. The edge server 20 functions as a relay for connecting, to the Internet 40, an apparatus connected to the local area network 45. The edge server 20 is an example of a monitoring system in the technology of the present disclosure.

The cloud server 30 is a server for managing video data or the like received from the monitoring camera 10 via the Internet 40.

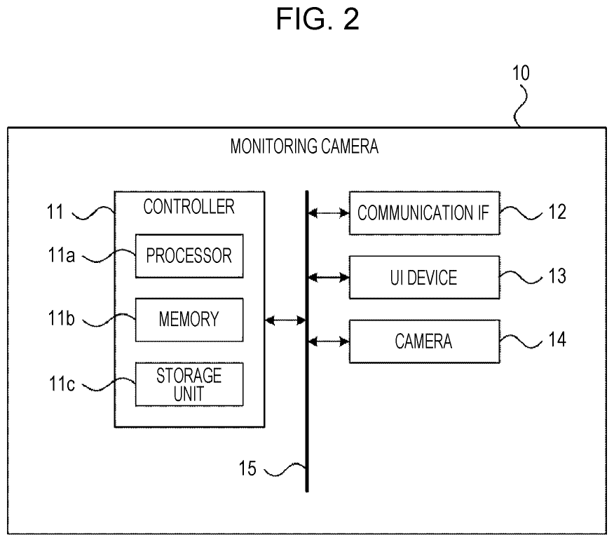

The hardware configuration of the monitoring camera 10 of this exemplary embodiment will then be described. FIG. 2 is a block diagram illustrating the hardware configuration of the monitoring camera 10.

As illustrated in FIG. 2, the monitoring camera 10 includes a controller 11, a communication interface (abbreviated as a communication IF) 12, a user interface device (abbreviated as a UI device) 13, and a camera 14. These components are connected to each other via a control bus 15.

The controller 11 includes a processor 11a, a memory 11b, and a storage unit 11c. The processor 11a performs predetermined processing on the basis of a program read out from the storage unit 11c and loaded into the memory 11b. The storage unit 11c is composed of a ROM, a HDD, or a SSD, or the like. The storage unit 11c stores various programs, data, and the like.

In this exemplary embodiment, the processor 11a reads out and runs the program stored in the storage unit 11c in the description; however, how the program is provided is not limited to this. The program may be provided in such a manner as to be recorded in the computer readable recording medium as described above. The program may also be acquired from an external apparatus via a communication network.

The communication IF 12 transmits and receives data to and from an external apparatus or the like. The UI device 13 is a device for a user to input information, such as a touch panel and/or a button.

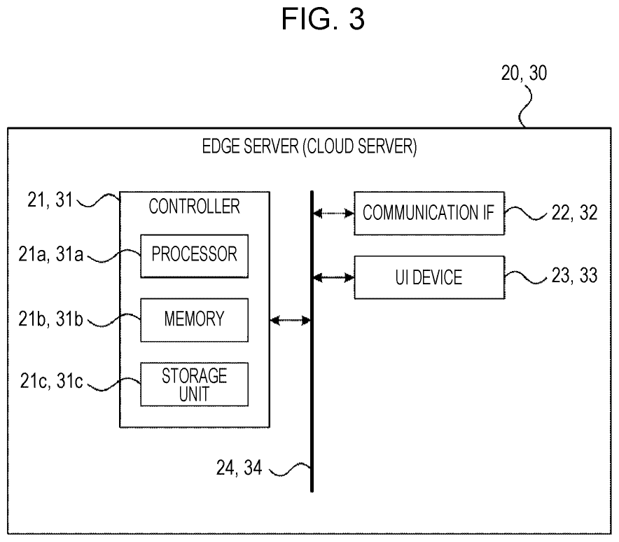

The hardware configuration of the edge server 20 of this exemplary embodiment will then be described. FIG. 3 is a block diagram illustrating the hardware configuration of the edge server 20. FIG. 2 is common to a block diagram illustrating the hardware configuration of the cloud server 30 (described later).

As illustrated in FIG. 3, the edge server 20 includes a controller 21, a communication IF 22, and a UI device 23. These components are connected to each other via a control bus 24.

The controller 21 includes a processor 21a, a memory 21b, and a storage unit 21c. The processor 21a performs predetermined processing on the basis of a control program read out from the storage unit 21c and loaded into the memory 21b. The storage unit 21c is composed of a ROM, a HDD, or a SSD, or the like. The storage unit 21c stores various programs, data, and the like.

In this exemplary embodiment, the processor 21a reads out and runs the program stored in the storage unit 21c in the description; however, how the program is provided is not limited to this. The program may be provided in such a manner as to be recorded in the computer readable recording medium as described above. The program may also be acquired from an external apparatus via the communication network.

The communication IF 22 transmits and receives data to and from an external apparatus or the like. The UI device 23 is a device for a user to input information, such as a mouse and/or a keyboard.

The hardware configuration of the cloud server 30 of this exemplary embodiment will then be described. As illustrated in FIG. 3, the cloud server 30 includes a controller 31, a communication IF 32, and a UI device 33. These components are connected to each other via a control bus 34.

These components are common to those of the edge server 20, and thus detailed description thereof is omitted.

Unauthorized rewriting of the boot program of the monitoring camera 10 connectable to the Internet 40 possibly causes a security hole in the network. Accordingly, the normality of the boot program of the monitoring camera 10 connectable to the Internet 40 is desirably guaranteed.

To meet the desire, the controller 11 of the monitoring camera 10 of this exemplary embodiment operates in the following manner. If it is validated that the boot program thereof is normal after referring to first validation information for validating the normality of the boot program, the controller 11 boots up the monitoring camera 10 by using the boot program. The controller 11 communicates with one or more different monitoring cameras 10 registered in advance and mutually validates that boot programs of the respective one or more different monitoring cameras 10 are normal after referring to second validation information for validating the normality of each boot program of a corresponding one of the different monitoring cameras 10. If it is mutually validated that the boot programs of the different monitoring cameras 10 the number of which is greater than or equal to a set number are normal, the controller 11 permits communication with an external apparatus such as the cloud server 30.

At least one of the first validation information or the second validation information may be a hash value of the boot program. The term “hash value” denotes different data generated from original data (herein the boot program) in accordance with a specific algorithm.

If the boot program is further composed of multiple programs in this case, the hash value of the boot program may be a hash value derived from each of the multiple programs constituting the boot program or a hash value derived from the entire boot program.

If a result of the validation of the normality of the boot program in the monitoring camera 10 matches with a result of the validation of the normality of the boot program in the corresponding different monitoring camera 10 in the monitoring system, the controller 11 may permit communication with the external apparatus such as the cloud server 30. The monitoring system acquires information from the monitoring camera 10 and the different monitoring camera 10 and validates consistency in the validation of the normality of the boot program, the information including the result in the different monitoring camera 10 and the result in the different monitoring camera 10.

In this case, the monitoring system may be implemented by the cloud server 30 or may be implemented by the edge server 20 in the local area network 45 including the monitoring camera 10. In this exemplary embodiment, for example, the edge server 20 is the monitoring system.

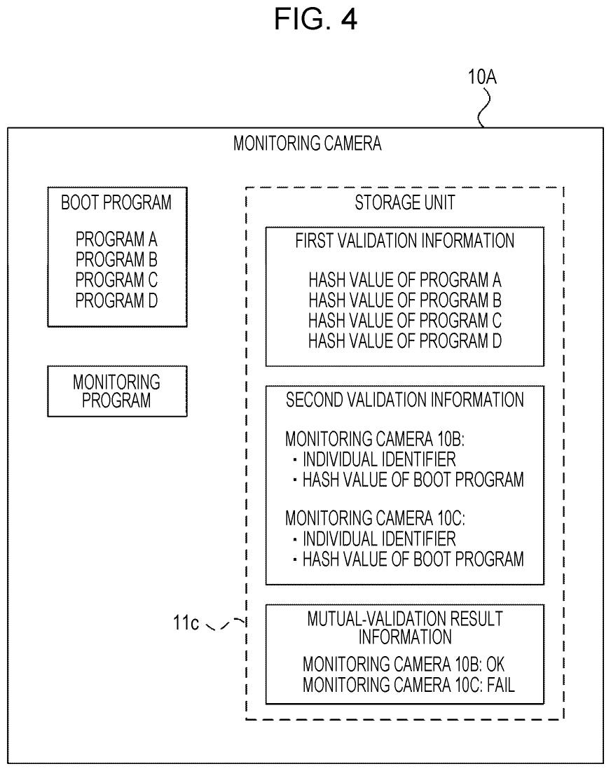

Hereinafter, processing in the monitoring camera 10 of this exemplary embodiment will be described in detail. FIG. 4 is a view for explaining the structure of data of the monitoring camera 10. FIG. 4 illustrates the structure of data of the monitoring camera 10A as an example, but the monitoring camera 10B and the monitoring camera 10C also have basically the same data structure.

The storage unit 11c of the monitoring camera 10 in advance stores the first validation information and the second validation information at the stage of factory shipping.

The first validation information is information for validating that the boot program of the monitoring camera 10 is normal. As illustrated in FIG. 4, in this exemplary embodiment, for example, the boot program of the monitoring camera 10 is composed of four programs that are Program A, Program B, Program C, and Program D. The first validation information is a hash value derived from each of the four programs.

The second validation information is information for validating that the boot program of a different monitoring camera 10 is normal. In the monitoring camera 10, different monitoring cameras 10 to be combined mutually in the normality guarantee system are known at the stage of factory shipping. In this exemplary embodiment, for example, the three cameras that are the monitoring camera 10A, the monitoring camera 10B, and the monitoring camera 10C are mutually combined. The second validation information is the individual identifier of each different monitoring camera 10 and a hash value derived from the entire boot program of the different monitoring camera 10.

For example, as illustrated in FIG. 4, the monitoring camera 10A stores, as the second validation information, the individual identifier of the monitoring camera 10B, a hash value derived from the entire boot program of the monitoring camera 10B, the individual identifier of the monitoring camera 10C, and the hash value derived from the entire boot program of the monitoring camera 10C.

When the monitoring camera 10 is booted up after the monitoring camera 10 is installed in the normality guarantee system, the controller 11 of the monitoring camera 10 validates that the boot program of the monitoring camera 10 is normal after referring to the first validation information for validating the normality of the boot program.

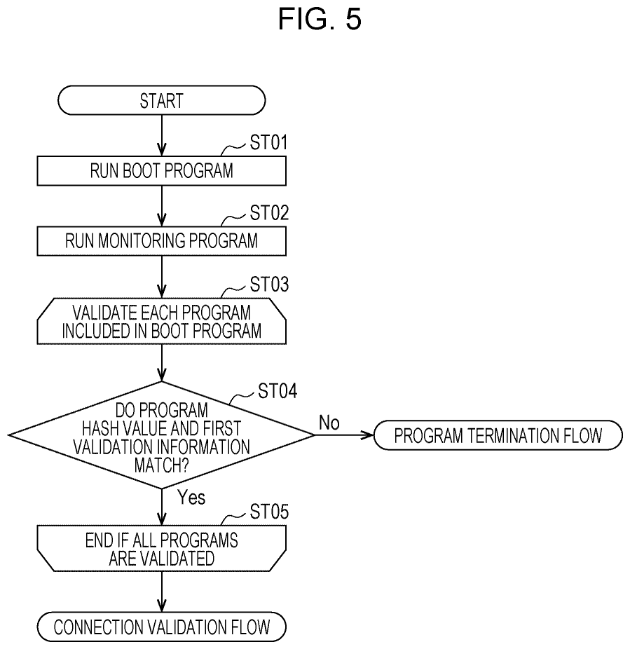

Specifically, as illustrated in a flowchart in FIG. 5, the controller 11 runs the boot program in step ST01.

In step ST02, the controller 11 then runs a monitoring program for validating, for example, the normality of the boot program.

In steps ST03 to ST05, the controller 11 then determines whether the hash value of the program run at the time of the boot-up and the first validation information match, for each program included in the boot program, on the basis of the monitoring program.

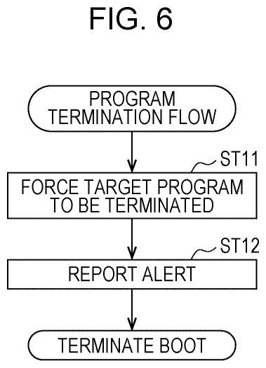

If the hash value of the program and the first validation information do not match in the determination in step ST04, the controller 11 transitions to a program termination flow illustrated in FIG. 6.

In the program termination flow, in step ST11, the controller 11 forcibly terminates the program determined as not matching with the first validation information.

In step ST12, the controller 11 then reports an alert indicating that the boot program is not normal and terminates the boot-up of the monitoring camera 10. The alert report may use any method, such as a report using an indicator such as a LED or a report using sound.

Referring back to FIG. 5, in steps ST03 to ST05, determination that the hash values of all of the programs match with the first validation information means that all of the programs included in the boot program are run, and thus the boot-up of the monitoring camera 10 is terminated. The controller 11 transitions to a connection validation flow (described later).

The controller 11 then communicates with each different monitoring camera 10 registered in advance and mutually validates that the boot program of the different monitoring camera 10 is normal after referring to second validation information for validating the normality of the boot program of the different monitoring camera 10. If it is mutually validated that the boot programs of the different monitoring cameras 10 the number of which is greater than or equal to the set number are normal, the controller 11 permits communication with the external apparatus such as the cloud server 30.

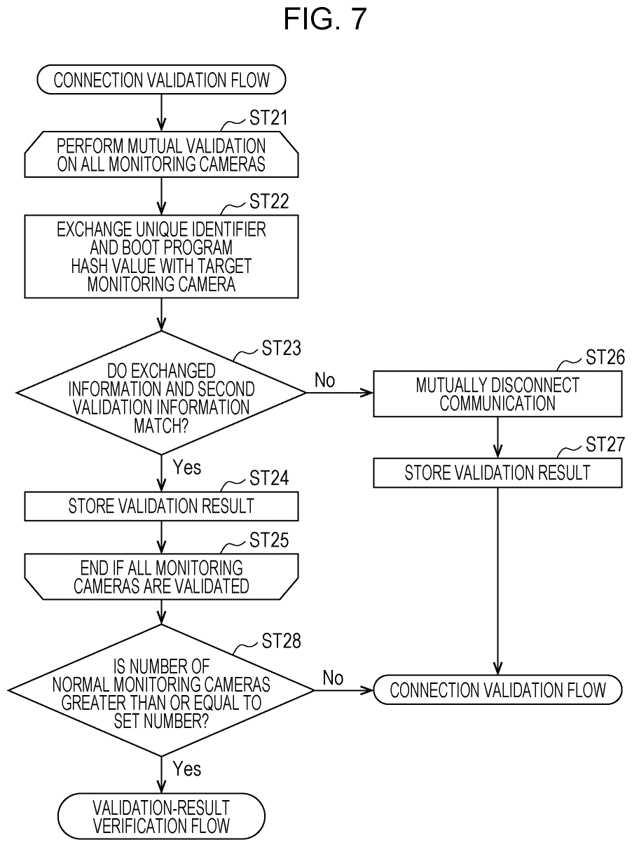

Specifically, as illustrated in a connection validation flowchart in FIG. 7, in steps ST21 to ST27, the controller 11 performs mutual validation on all of the monitoring cameras 10 included in the second validation information on the basis of the monitoring program. The controller 11 stores the result of the mutual validation in the storage unit 11c, as mutual-validation result information.

For example, as illustrated in FIG. 4, the monitoring camera 10A stores information regarding the monitoring camera 10B and the monitoring camera 10C, as the second validation information. In the monitoring camera 10A, the mutual validation is thus performed on the monitoring camera 10B and the monitoring camera 10C.

In the mutual validation, for each different monitoring camera 10, the controller 11 exchanges the unique identifier and the hash value of the boot program with the target monitoring camera 10 in step ST22.

In step ST23, the controller 11 then determines whether the exchanged information and the second validation information match.

If the exchanged information and the second validation information do not match in the determination in step ST23, the controller 11 mutually disconnects communication with the target monitoring camera 10 in step ST26.

In step ST27, the controller 11 then stores the validation result in the storage unit 11c and thereafter transitions to the first step in the connection validation flow.

If the exchanged information and the second validation information match in the determination in step ST23, the controller 11 stores the validation result in the storage unit 11c in step ST24.

After performing the mutual validation on all of the monitoring cameras 10 in step ST25, the controller 11 determines whether the number of normal monitoring cameras 10 is greater than or equal to the set number in step ST28.

In this exemplary embodiment, the three monitoring cameras 10 are provided in the normality guarantee system. Each monitoring camera 10 performs the mutual validation on the two different monitoring cameras 10. The upper limit of the set number is thus 2, and 1 is herein set. Any value may be set as the set number, for example, the total number of monitoring cameras 10 to undergo the mutual validation is set.

If the number of normal monitoring cameras 10 is less than the set number in the determination in step ST28, the controller 11 transitions to the first step in the connection validation flow.

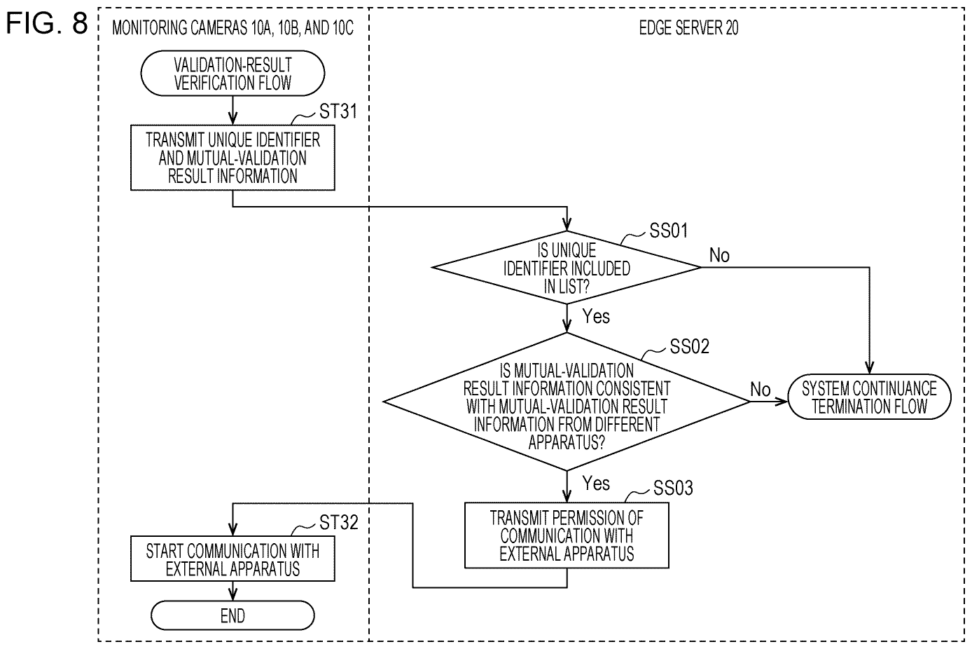

If the number of normal monitoring cameras 10 is greater than or equal to the set number in the determination in step ST28, the controller 11 transitions to a validation-result verification flow illustrated in FIG. 8.

If the result of the validation of the normality of the boot program in the monitoring camera 10 matches with the result of the validation of the normality of the boot program in the different monitoring camera 10 in the edge server 20, the controller 11 then permits communication with the external apparatus such as the cloud server 30. The edge server 20 acquires the information from the monitoring camera 10 and the different monitoring camera 10 and validates the consistency in the validation of the normality of the boot program, the information including the result in the different monitoring camera 10 and the result in the different monitoring camera 10.

Specifically, as illustrated in a validation-result verification flowchart in FIG. 8, in step ST31, the controller 11 of the monitoring camera 10 transmits the unique identifier and the mutual-validation result information of the monitoring camera 10 to the edge server 20, on the basis of the monitoring program.

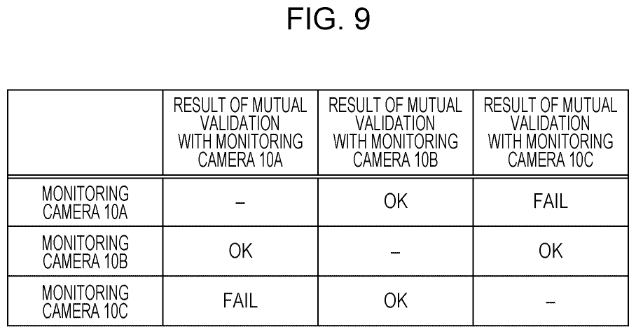

This is performed on all of the monitoring camera 10A, the monitoring camera 10B, and the monitoring camera 10C included in the normality guarantee system. Accordingly, as illustrated in FIG. 9, the unique identifiers and the mutual-validation result information of all of the monitoring camera 10A, the monitoring camera 10B, and the monitoring camera 10C are aggregated in the edge server 20.

The storage unit 21c of the edge server 20 in advance stores a list of the unique identifiers of all of the monitoring camera 10A, the monitoring camera 10B, and the monitoring camera 10C included in the normality guarantee system.

The controller 21 of the edge server 20 then performs the following processing for each monitoring camera 10 on the basis of the control program. First, the controller 21 determines whether one of the unique identifiers that is received from the monitoring camera 10 is included in the list in step SS01.

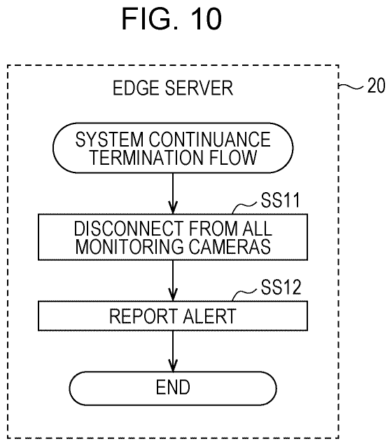

If the unique identifier received from the monitoring camera 10 is not included in the list in the determination in step SS01, the controller 21 transitions to a system continuation termination flow illustrated in FIG. 10.

In the system continuation termination flow, in step SS11, the controller 21 disconnects from all of the monitoring cameras 10.

In step SS12, the controller 21 then reports an alert indicating that the normality guarantee system is not normal and terminates the processing. The alert report may use any method, such as a report using an indicator such as a LED or a report using sound.

Referring back to FIG. 8, if the unique identifier received from the monitoring camera 10 is included in the list in the determination in step SS01, the controller 21 determines in step SS02 whether the mutual-validation result information received from the monitoring camera 10 is consistent with the mutual-validation result information received from the different monitoring camera 10.

If the mutual-validation result information received from the monitoring camera 10 is not consistent with the mutual-validation result information received from the different monitoring camera 10 in the determination in step SS02, the controller 21 transitions to the system continuation termination flow illustrated in FIG. 10 described above.

If the mutual-validation result information received from the monitoring camera 10 is consistent with the mutual-validation result information received from the different monitoring camera 10 in the determination in step SS02, the controller 21 transmits a permission for communication with the external apparatus to the monitoring camera 10 in step SS03.

In response to the reception of the communication permission from the edge server 20, the controller 11 of the monitoring camera 10 starts communication with the external apparatus such as the cloud server 30 in step ST32.

Modification The information processing system of the exemplary embodiment of the present disclosure has heretofore been described; however, the technology of the present disclosure is not limited to the exemplary embodiment above and may also be changed appropriately.

For example, the monitoring camera 10 is taken as an example of the information processing system in the description for the exemplary embodiment; however, any IoT device connectable to the Internet 40, such as a human sensor, may be used as the information processing system.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the technology of the present disclosure, the system includes both of a system including multiple apparatuses and a system including one apparatus.

The technology of the present disclosure is also applicable to a program and a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system includes:
a processor configured to:
   in response to boot program normality of a boot program of the information processing system being validated after referring to first validation information for validating the boot program normality, boot up the information processing system with the boot program;
   communicate with one or more different systems registered in advance and mutually validate boot program normality of one or more boot programs of the respective one or more different systems after referring to second validation information for validating the boot program normality of each of the one or more boot programs of a corresponding one of the different systems; and
   in response to the boot program normality of the boot program of the different system a count of which is greater than or equal to a set count being mutually validated, permit communication with an external apparatus.
      (((2)))

In the information processing system according to (((1))),
at least one of the first validation information or the second validation information is a hash value of the boot program.
   (((3)))

In the information processing system according to (((2))),
the boot program includes multiple programs, and
the hash value of the boot program is a hash value derived from each of the multiple programs included in the boot program.
   (((4)))

In the information processing system according to (((2))),
the boot program includes multiple programs, and
the hash value of the boot program is a hash value derived from entirety of the boot program.
   (((5)))

In the information processing system according to any one of (((1))) to (((4))),
the processor is configured to:
   in response to a result of validation of the boot program normality in the information processing system matching with a result of validation of the boot program normality in the different system in a monitoring system, permit communication with the external apparatus, the monitoring system acquiring information from the information processing system and the different system and validating consistency in the validation of the boot program normality, the information including the result in the information processing system and the result in the different system.
      (((6)))

In the information processing system according to (((5))),
the monitoring system is implemented by a cloud server.
   (((7)))

In the information processing system according to (((5))),
the monitoring system is implemented by an edge server in a local area network including the information processing system.
   (((8)))

A program causes a computer to execute a process including:
in response to normality of a boot program of an information processing system being validated after referring to first validation information for validating the normality of the boot program, booting up the information processing system with the boot program;
communicating with one or more different systems registered in advance and mutually validating normality of one or more boot programs of the respective one or more different systems after referring to second validation information for validating the normality of each of the one or more boot programs of a corresponding one of the different systems; and
in response to normality of the boot program of the different system a count of which is greater than or equal to a set count being mutually validated, permitting communication with an external apparatus.
   (((9)))

A normality guarantee system includes:
multiple information processing systems each including a processor; and
a monitoring system,
the processor configured to:
   in response to boot program normality of a boot program of a corresponding one of the multiple information processing systems being validated after referring to first validation information for validating the boot program normality, boot up the information processing system with the boot program;
   communicate with one or more different systems registered in advance and mutually validate boot program normality of one or more boot programs of the respective one or more different systems after referring to second validation information for validating the boot program normality of each of the one or more boot programs of a corresponding one of the different systems; and
   in response to the boot program normality of the boot program of the different system a count of which is greater than or equal to a set count being mutually validated, and in response to a result of validation of the boot program normality in the information processing system matching with a result of validation of the boot program normality in the different system in the monitoring system, permit communication with an external apparatus, the monitoring system acquiring information from the multiple information processing systems and validating consistency in the validation of the boot program normality, the information including the result in the information processing system and the result in the different system.

What is claimed is:

1. An information processing system comprising:
a processor configured to:
in response to boot program normality of a boot program of the information processing system being validated after referring to first validation information for validating the boot program normality, boot up the information processing system with the boot program;
communicate with one or more different systems registered in advance and mutually validate boot program normality of one or more boot programs of the respective one or more different systems after referring to second validation information for validating the boot program normality of each of the one or more boot programs of a corresponding one of the different systems; and
in response to the boot program normality of the boot program of the different system a count of which is greater than or equal to a set count being mutually validated, permit communication with an external apparatus.

2. The information processing system according to claim 1,
wherein at least one of the first validation information or the second validation information is a hash value of the boot program.

3. The information processing system according to claim 2,
wherein the boot program includes a plurality of programs, and
wherein the hash value of the boot program is a hash value derived from each of the plurality of programs included in the boot program.

4. The information processing system according to claim 2,
wherein the boot program includes a plurality of programs, and
wherein the hash value of the boot program is a hash value derived from entirety of the boot program.

5. The information processing system according to claim 1,
wherein the processor is configured to:
in response to a result of validation of the boot program normality in the information processing system matching with a result of validation of the boot program normality in the different system in a monitoring system, permit communication with the external apparatus, the monitoring system acquiring information from the information processing system and the different system and validating consistency in the validation of the boot program normality, the information including the result in the information processing system and the result in the different system.

6. The information processing system according to claim 5, wherein the monitoring system is implemented by a cloud server.

7. The information processing system according to claim 5,
wherein the monitoring system is implemented by an edge server in a local area network including the information processing system.

8. A non-transitory computer readable medium storing a program causing a computer to execute a process comprising:
in response to normality of a boot program of an information processing system being validated after referring to first validation information for validating the normality of the boot program, booting up the information processing system with the boot program;
communicating with one or more different systems registered in advance and mutually validating normality of one or more boot programs of the respective one or more different systems after referring to second validation information for validating the normality of each of the one or more boot programs of a corresponding one of the different systems; and
in response to normality of the boot program of the different system a count of which is greater than or equal to a set count being mutually validated, permitting communication with an external apparatus.

9. A normality guarantee system comprising:
a plurality of information processing systems each including a processor; and
a monitoring system,
the processor configured to:
in response to boot program normality of a boot program of a corresponding one of the plurality of information processing systems being validated after referring to first validation information for validating the boot program normality, boot up the information processing system with the boot program;
communicate with one or more different systems registered in advance and mutually validate boot program normality of one or more boot programs of the respective one or more different systems after referring to second validation information for validating the boot program normality of each of the one or more boot programs of a corresponding one of the different systems; and
in response to the boot program normality of the boot program of the different system a count of which is greater than or equal to a set count being mutually validated, and in response to a result of validation of the boot program normality in the information processing system matching with a result of validation of the boot program normality in the different system in the monitoring system, permit communication with an external apparatus, the monitoring system acquiring information from the plurality of information processing systems and validating consistency in the validation of the boot program normality, the information including the result in the information processing system and the result in the different system.
